(19) United States
(12) Patent Application Publication
(10) Pub. No.: US 2007/0104181 A1
(43) Pub. Date: May 10, 2007

(54) SYSTEM AND METHOD FOR A MEDIA INTERNET CHANNEL STATION (MICS) TO CONNECT TO AND ACCESS MEDIA CONTENT UTILIZING MEDIA DOMAIN NAME (MDN) CHANNELS WITH THREE MODES

(76) Inventors: David Hee-Don Lee, Alexandria, VA (US); John Jeongho Park, Alexandria, VA (US); Sang H. Mun, Seoul (KR); Stephen Woojin Baek, Alexandria, VA (US); Jae Jun Han, Seoul (KR)

Correspondence Address: DAVID H. LEE, 6606 SCHURTZ ST., ALEXANDRIA, VA, 22310, US

(21) Appl. No.: 11/164,082

(22) Filed: Nov. 9, 2005

(51) Int. Cl. H04L 12/66

(52) U.S. Cl. 370/352; 370/401

(57) ABSTRACT

A system and method of connecting and accessing the Internet Media Domain Name (MDN) channels with multiple media content from local media servers to client nodes by using a Media Channel-Routing Internet Protocol (mCh-IP) in a Media Internet Channel Station (MICS). For the first mode of the MICS, a private Media Channel Domain Root Server (mCh-DRS) resolves an MDN channel to the channel IP of the media server or the media content files to directly connect to and access the media content. For the second mode of the MICS, a Channel Access Control Key System (CHACKS) using a Media Channel-Routing Authentication Server (mCh-AS) provides a DRM protected channel mode between the media server of the provider and the client node. Finally, the last mode of the MICS is a Payment Channel Access Control Key System (Pay-CHACKS) using a Media Channel-Routing Payment Server (mCh-PS) for providing a payment channel mode in the Internet media channel.

### FIELD OF THE INVENTION

The present invention relates to Internet media services, and more particularly, to providing a client node on an Internet connection with the ability to directly access multiple channel content in media servers.

### BACKGROUND OF THE INVENTION

Recently people have begun to provide or share their media effectively with other people using the Internet. The Internet has become ideal for sharing media due to the development of higher broadband speeds, inexpensive and readily available personal computer memory, development of mobile phones and wireless devices, and advanced digital cameras and camcorders. Also, people have a desire to present their own media files to other people in the cyber world. Therefore, Internet media services are poised to replace the existing media services such as TV, radio, and cable broadcast. There are currently two kinds of Internet media services, center-oriented broadcasting methods, and local-oriented media sharing methods.

An example of center-oriented broadcasting methods is Internet Protocol Television (IP TV). The IP TV uses a two-way digital television or video signal along with a set-top box programmed with software that can handle viewer requests to access media sources over an Internet Protocol (IP) based network and bundles with voice or data products from private Internet providers such as cable and telephone companies. Due to the high bandwidth requirements for video file streaming, IP TV must have broadband connections in order for content to be distributed well.

IP TV requires media viewers to have a set-top box with programmed software connected to a TV. With this type of Internet media service, the TV providers must provide a particular digital signal to utilize an IP TV system. In addition, the IP TV has limited number of channels even though there are hundreds of channels. For an individual user or a small entity, it is very hard to get a fixed channel that shares private media contents to others.

An example of local-oriented media sharing methods is “viog” (short for video weblog). A viog is a blog (or weblog) as the primary content as it is linked to an internal viog post directory and usually accompanied by supporting text, images, and additional meta data to provide a content for the video. The viog provides the ability to attach media files to a viog post directory, and it is possible to bypass the mainstream intermediaries and openly distribute media files to the masses via the Internet.

Vlogs rely on the local viogger's limited content so it is hard to manage the constancy of each viog as a media channel. Also, for viogs, the users have to stop by the directory of a viog website to connect to a viogger's content.

In addition to the weakness of the IP TV and the Vlogs, there is lack of media resource blocking method, secure content protection method, and online payment method in the existing Internet media service. While people can connect to and access any computer resources by Internet system, some countries or communities may want to block a certain type of media content. Also, media providers need to securely protect their media content while they broadcast it under their community. In addition, the new Internet media service should be required to have payment method for the media providers.

In short, the existing Internet media services have significant limitations.
(1) An IP TV relies on a certain set-top box programmed with particular software to broadcasting media content
(2) An IP TV provides only limited numbers of channel stations, so it is very hard for an individual user or small entities to have a fixed channel station.
(3) A customer must initially connect to a post directory or a web server of a media provider to get the media files.
(4) It may be complicated to search media content in a media server unless there is direct connection.
(5) The directory service must manage heavy amount of network traffic load to connect client nodes to media content of providers.
(6) There is lack of Media blocking methods that control and filter media content in an Internet community.
(7) There is lack of secure protection methods of media files for releasing media channels.
(8) The existing Internet media distribution methods do not have securely protected payment systems.
(9) A media provider needs a method to create fixed media channels for its media content.
(10) The existing Internet media services have limited media channels and content.
(11)

The present invention overcomes the disadvantages of existing systems. It creates an Internet media channel broadcasting station that provides channels for media content files to Internet media servers.

### SUMMARY OF THE INVENTION

Accordingly, the present invention provides a more efficient system and method to connect to and access Internet Media Domain Name (MDN) channels which make a variety of media content available to people online with three modes which are a basic open channel mode, a DRM protected channel mode, and a payment channel mode. The MDN channels consist of a media prefix and a domain name, so they represent a media server or a media content file directory.

In one embodiment of the present invention, content at the media servers (MSs) of Internet media channel providers (MCPs) are directly connected to client nodes by utilizing a MDN channel with a Media Channel-Routing Internet Protocol (mCh-IP) at a Media Internet Channel Station (MICS). The MICS is a media link agent operating the mCh-IP method to let a client node connect to and access the media content files at a media server. A client node initially has to download and install a plug-in program from the MICS to set up a private tunnel between the node and the MICS.

In another embodiment, the present invention directly resolves Internet MDN channels to the channel IP of the media servers or the media content files through a private Media Channel Domain Root Server (mCh-DRS) for providing a basic mode between the media server of the Internet media channel provider and the client node. The media channel provider initially registers the channel IP of the media server or media content file directory into the mCh_DRS of the MICS. Any individual user or small entities are able to make their own media channel for the media content file, so there is no limitation to make a private Internet media channel.

In another embodiment, the present invention grants a Channel Access Control Key System (CHACKS) using a Media Channel-Routing Authentication Server (mCh-AS) for providing a Digital Rights Management (DRM) protected channel mode between the media server of the Internet media channel provider and the client node. Therefore, the MDN channel can only be accessed by authorized client nodes, so that the media content is not be freely distributed.

In another embodiment, the present invention grants a Payment Channel Access Control Key System (Pay-CHACKS) by using a Media Channel-Routing Payment Server (mCh-PS) for providing a payment channel mode between the media server of the Internet media channel provider and the client node. Therefore, the Media Channel Provider keeps its media channel content to a paid service using paid media encryption and decryption keys.

These and other aspects of the present invention will be better described with reference to the Detailed Description of the Drawings and the accompanying figures.

### BRIEF DESCRIPTION OF THE DRAWING

The preferred embodiments of the present invention are shown by way of example in, not limited by, the accompanying figures, in which:

FIG. 1 is a diagram of a logical network topology illustrating the method of an MICS to connect to and access MDN channels at Internet Media Channel Providers (MCPs);

FIG. 2 illustrates different network connection flows between an existing IP method and an mCh-IP method of the present invention to connect to and access the media files of an media server;

FIG. 3 is a flow chart illustrating the steps of the MICS system and method to connect to and access media files of an Internet media server from a CN;

FIG. 4 is a practical business model using the MICS method as an iLog TV live media broadcasting channel service;

FIG. 5 is a diagram illustrating the basic channel mode of the MICS system of the present invention;

FIG. 6 is a diagram illustrating the CHACKS DRM channel protected mode of the MICS system of the present invention;

FIG. 7 is a diagram illustrating the Pay-CHACKS channel mode of the MICS system of the present invention; and

FIG. 8 is a flow chart and a channel mode table illustrating how business media channel modes are decided and what types and purposes are required for each mode of the MICS system of the present invention.

### DETAILED DESCRIPTION OF THE DRAWINGS

While the present invention may be embodied in many different business applications, a number of illustrative embodiments are described herein with the understanding that the present disclosure is to be considered as providing examples of the principles of the invention and that such examples are not intended to limit the invention to preferred embodiments described herein and illustrated herein.

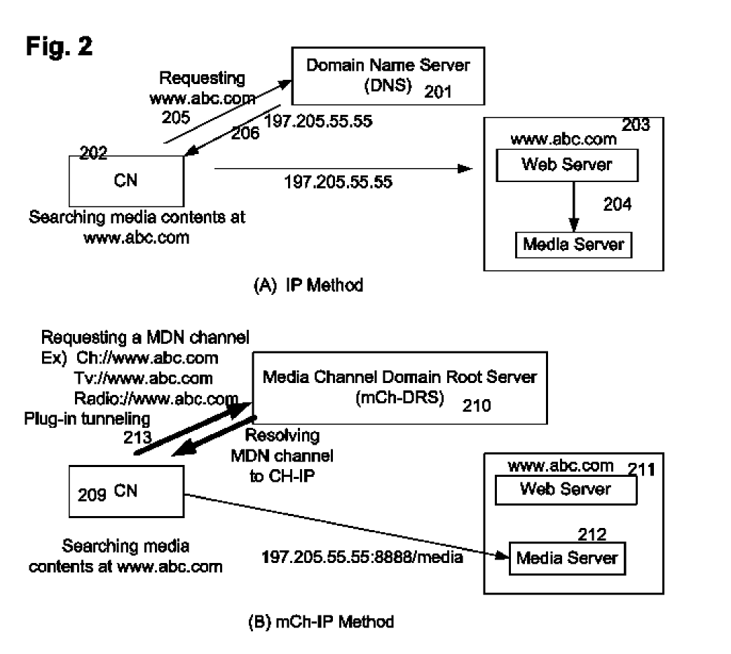

FIG. 2(A) describes an existing DNS (Domain Name Server) system with an IP address method between a client node as an Internet user and a Web server as an Internet content provider. For the existing DNS system, the client node 202 has to know and input an extended folder name in addition to a domain name to connect to and access media files in the media server 204 linked with the Web Server 203. If a client node wants to search media files at www.abc.com, it initially sends a request resolving the domain name 205 to a public DNS 201. Then the public DNS finds and sends the corresponding IP address 206 of the Web server to the client node. After the client node receives the IP address of the Web server, the www.abc.com can be accessed. However, it has to access a further step 208 to get to media files of the media server. The client node has to search media files in the media server since the files may be placed some subdirectories.

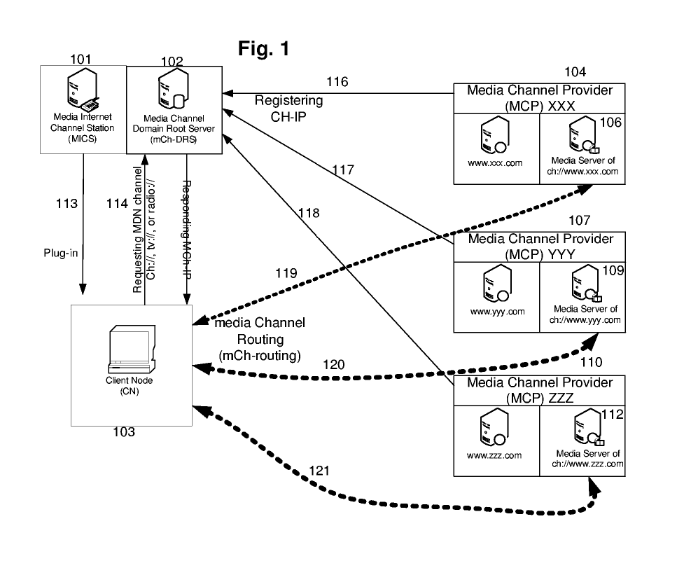

FIG. 1 illustrates general basic concept of the present invention in a logical network topology. With reference to FIG. 1, the system and method of the present invention allows a client node (CN) 103 to directly connect to internet media files of media servers 106, 109, and 112 of individual Media Channel Providers (MCPs) 104, 107, and 110. The Media Internet Channel Station (MICS) 101 as a link agent operates the Media Channel-routing Internet Protocol (mCh-IP) method to make the node find out the media files. There are two stages of the MICS method which are an initial stage and a normal stage. For the initial stage of the mCh-IP system of the present invention in the FIG. 1, the media channel providers register the media server IPs 116, 117, and 118 into the Media Channel Domain Root Server (mCh-DRS) 102. Alternatively, the media channel providers may register full IP addresses for directories of the media content files in the media server. The mCh-DRS links each registered media server IP or a media content file directory with a Media Domain Name (MDN) channel which consists of a Media Prefix (MP) in front of the regular domain name of an MCP. The function of the MP is the same as FTP, MMS, Telnet, and HTTP. The MP Examples of the present invention are kinds of media names such as ch://, tv://, radio://, movie://, music://, mp3://, photo://, or message://. The example of MDN channels is ch://www.abc.com, tv://www.abc.com or radio://www.abc.com for an MCP of www.abc.com. Therefore, an MCP doesn't have to create a new MDN channel name for its media channel content. When a client node (CN) 103 accesses an MICS, the CN downloads and installs a plug-in program 113 from the MICS. The plug-in program sets up a private tunnel between the client node and mCh-DRS to recognize the MDN channel as a mCh-IP. The private tunnel may adapt a Virtual Private Network (VPN).

As a normal stage, the client node writes a MDN channel 114 at a web browser instead of a regular domain name. Then the MDN channel is automatically sent to a private mCh-DRS at a MICS for directly resolving the MDN to the IP address for the media server of an MCP since the client node has a plug-in program and an mCh-IP method. After that, the mCh-DRS sends the corresponding IP address of the media server to a client node, and the CN is directly connected with the media server of the media provider to access media files. Therefore, a user can easily have direct media channel routing (mCh-Routing) 119, 120, 121 to connect to and access the media content of the media server only if a client node writes a simple MDN channel format in the address box instead of an existing URL. Also, the MDN could be a fixed media station channel name which works without breaking the existing Internet domain system.

An example of a logical network topology of the proposed MICS model to connect to and access the MDN channels according to a preferred embodiment of the invention is illustrated in FIG. 1. Also, FIG. 2 is simplified diagrams illustrating the difference between an existing IP method FIG. 2(A) and the MDN channel of mCh-IP method FIG. 2(B) to connect to and access the media files in a media server of an MCP. For an existing IP method, a CN 202 requests a domain name 205 to a public DNS 201 to connect a web server, and access media contents of an MS 204 from the server 203 after acquiring the channel IP of the media server 206, 207. On the other hand, for a mCh-IP method, a CN 209 directly requests an MDN channel 213 to a private mCh-DRS 210, and the CN connects to and accesses media content of MS 212 without bypassing the web server 211. The media contents are comprised of TV, radio, movie, music, mp3, photo, or text message in the media servers of any media provider.

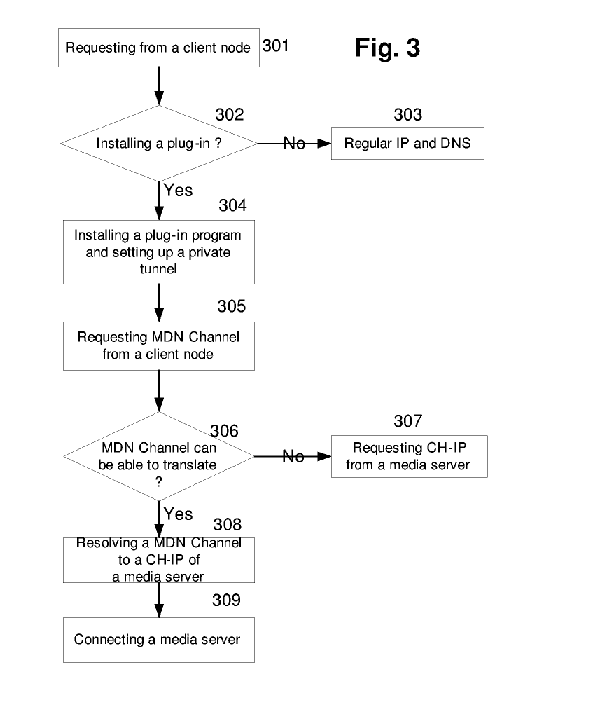

With reference to FIG. 3, a flow chart of an MICS shows the way to connect a media server to a client node. Starting at step 301 of FIG. 3, an MICS having a mCh-DRS implemented therewith receives an application for media channel service from a CN. At step 302, the MICS determines whether the CN wants a plug-in from MICS or not. If a CN does not install a basic plug-in, the CN still can be connected and access media files by using an existing IP and DNS method at step 303. If the CN agrees and installs the plug-in, then the MICS sends a plug-in program and sets up a private tunnel at step 304. At step 305, the mCh-DRS receives an MDN channel requesting message from the CN. At step 306, the mCh-DRS determines whether the requested MDN channel is able to translate or not. If the mCh-DRS is not able to translate the MDN channel, it would request a corresponding channel IP for a media server to a Media Channel Provider (MCP) at step 307. If the mCh-DRS is able to translate the MDN channel, it would resolve the MDN Channel to the Channel IP of the media server at step 308. Finally, at step 309, the CN directly connects to an Internet media server to access media content.

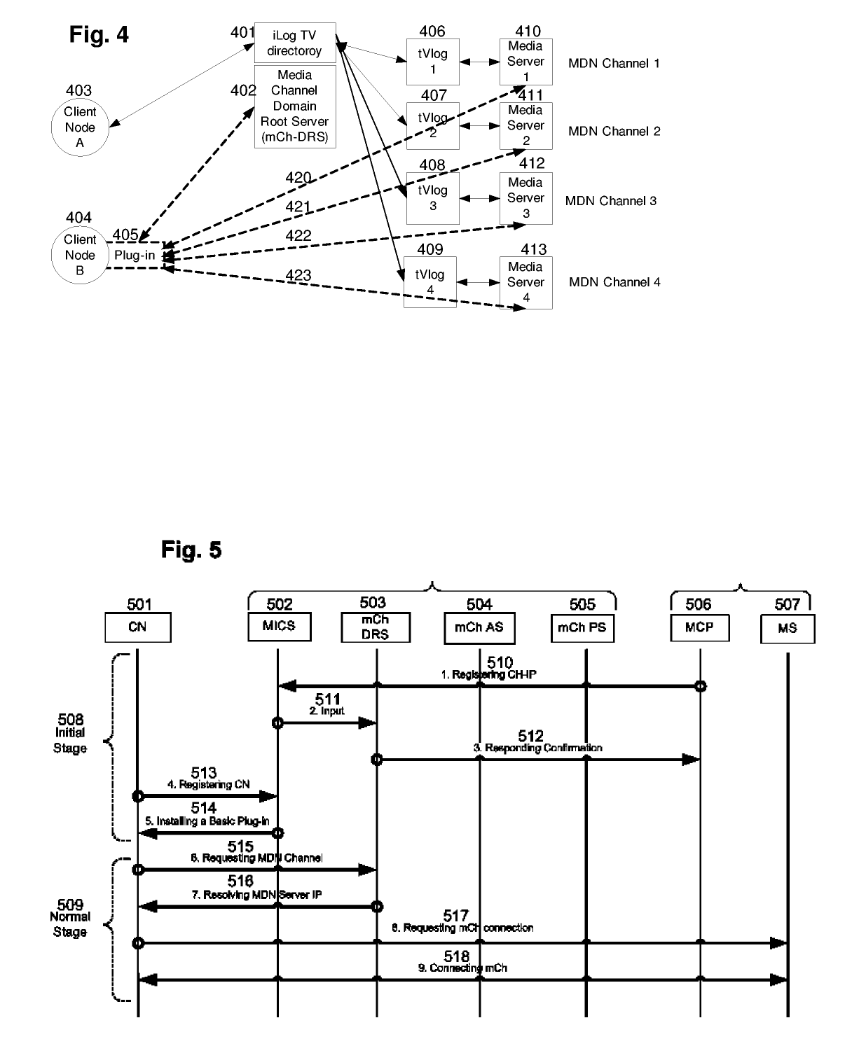

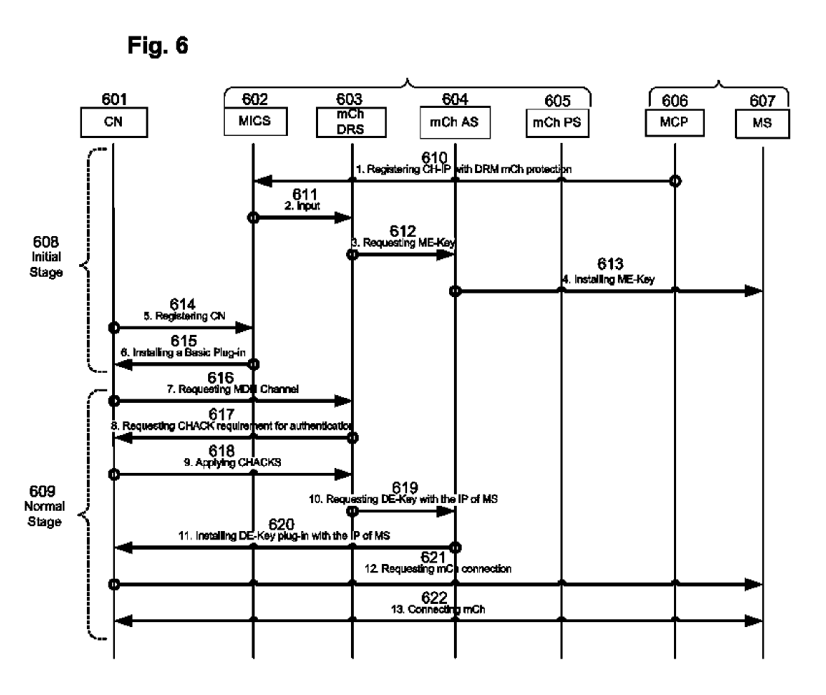

FIG. 4 is a practical business model by using the MICS method as an iLog TV live media broadcasting service. In the system and method of iLog TV 401, client nodes 403, 404 are users who connect to and watch one of the live TV channels, and tv logs 406, 407, 408, 409 are live TV channel providers who broadcast their TV content from the media servers 410, 411, 412, 413. The client node ‘A’ 403 initially may choose one of the tvlogs from the directory of iLog TV 401, and accesses media files in the media server of a tvlog. However, the client node ‘B’ 404 could directly and simply connect and access media files right after it requests resolving an MDN channel to a private mCh-DRS 402. For the initial stage of an mCh-DRS of iLog TV, the client node needs to download and install a plug-in program 405 to adapt the method of MDN channel. The system and method of the present invention is peer-to-peer network connections 420, 421, 422, 423. [Para 31]A detailed diagram of proposed the MICS method according to a preferred embodiment of the invention is illustrated in FIG. 5 and FIG. 6. FIG. 5 explains the detailed system diagram among a Client Node (CN) 501, an MICS, and a Media Channel Provider (MCP) for a basic mode of the MICS system of the present invention. An MICS consists of a MICS client interface 502, an mCh-DRS 503, a Media Channel Authentication Server (mCh-AS) 504, and a Media Channel Payment Server (mCh-PS) 505, while an MCP consists of an MCP Web interface 506 and a Media Server (MS) 507. The MICS method consists of two stages, which are an initial stage 508 and a normal stage 509. When an MCP 506 registers the channel IP of the media server or the media content files into an MICS for joining the system and method of the present invention as an initial stage between an MCP and an MICS at step 510, the MICS 501 inputs the information into a look-up table of the mCh-DRS 503 as a domain name root server at step 511. And then, the mCh-DRS responds to the request of the MCP as a confirmation of the registration at step 512. For the initial stage between the CN 501 and the MICS 502, the CN applies its information to the MICS for providing the service and getting a basic plug-in program at step 513. Then, the MICS sends a basic plug-in for the CN to install it into the system at step 514.

For the start of the normal stage 509 between the CN 501 and the MICS 502, the CN requests the MDN channel to the mCh-DRS 503 of the MICS to directly connect to the media content of a media server 507 as a channel at step 516. For instance, the CN could send the MDN channel, such as ch://www.abc.com, tv://www.abc.com, or radio://www.abc.com etc., instead of a Web URL to get the media content from www.abc.com. Then, the mCh-DRS of the MICS resolves the MDN channel to the channel IP of the media server or the media content files of MS since the mCh-DRS already has the information from the MCP at step 516. In this way, the CN 501 directly requests a channel connection to the MS 507 of the MCP at step 517, and accesses media content immediately at step 518 without requesting public DNS and searching the content from the Web site of the MCP 506.

FIG. 6 shows a diagram illustrating the roles of each node of the MICS system of the present invention in the case of a media content secure protection mode using media keys. When a media provider wants to apply a digital rights management (DRM) to protect the copyrights of the digital media content in the MDN channel by enabling secure distribution or disabling illegal distribution of the media content, the MCP requests a DRM system to the MICS for its MDN channel. The DRM system protects intellectual property by encrypting and decrypting the media data with a Channel Access Control Key Systems (CHACKS) mode, so that the MDN channel can only be accessed by authorized client nodes and the media content can not be freely distributed.

In order to work with the CHACKS mode in the MICS method as a DRM system, there are initial stage 608 and normal stage 609 among the CN 601, the MICS, and the MCP same as the basic mode of the MICS. For the initial stage, the MCP 606 registers the channel IP of the media server and applies DRM mCh protection for the media channel contents into the MICS 602 at step 610, and the MICS inputs the information to the mCh-DRS 603 at step 611. Then, the mCh-DRS requests a Media Encoding Key (ME-Key) for the MS to mCh Authentication Server (mCh-AS) 604 at step 612, and the mCh-AS sends a confirmation packet of the registration and a CHACKS plug-in with the ME-Key to the MS 607 of the MCP 606 to install it for encrypting the media channel at step 613. A corresponding Media Decoding Key (MD-Key) is required to decrypt the encrypted media content of the MDN channel. When a CN utilizes the MICS, it registers itself in an initial stage 608 between a CN 601 and the MICS 602 at step 614. And then, the MICS provides a basic mCh plug-in for the CN to install it for the mCh-IP system and method of this invention at step 615. Now, the MICS system is about to start to a normal stage for the next step among different nodes after set up the initial stage.

In the normal stage 609 of the MICS with the CHACKS mode, after the CN 601 requests the MDN channel to the mCh-DRS 603 of the MICS at step 616, the mCh-DRS resolves the MDN channel to the channel IP of the media server or the media content files and decides whether the CHACKS mode is required or not. If the CHACKS mode is required for the MDN channel, the mCh-DRS 603 holds sending the channel IP and sends a request of user information to the CN 601 for media channel access control authentication at step 617. After the user of the client node applies the CHACKS mode at step 618, the mCh-DRS 603 delivers the IP address of the MS to the mCh-AS 604 and requests for mCh-AS to make a DE-Key for CN at step 619. The mCh-AS 604 sends a DE-Key plug-in program for installation to the CN with the channel IP of the MS at step 620. After getting the DE-Key, the CN directly connects to the media server channel immediately at step 621. When the connection between the CN 601 and the MS 607 is completed, only the CN which has the MD-Key can get media content from the Media Server at step 622 since all of the media content of the Media Server are already encrypted with the ME-Key. The MD-Key is effective unless the media provider or the MICS change the CHACKS key information. Therefore, the CN doesn't have to get the MD-Key every time to access the same media channel since it is just a one time registration process.

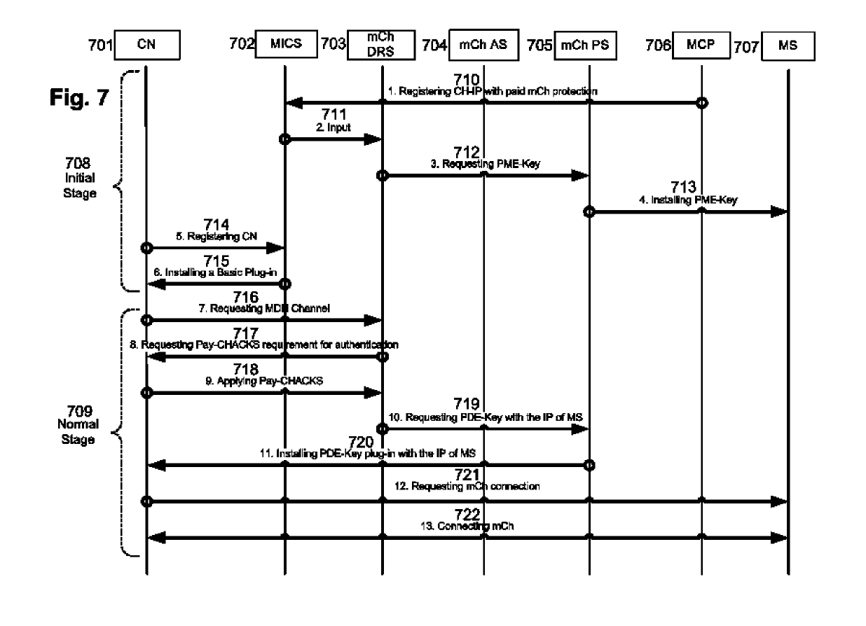

FIG. 7 shows a diagram illustrating the roles of each node of the MICS system of the present invention when the MCP wants to keep its media channel content to a paid service using paid media encryption and decryption keys. The MCP 706 could request a Payment Channel Access Control Key System (Pay-CHACKS) mode to the MICS 702 at the process of registering the channel IP of the media server or media content files matching with the mCh-DNS as an initial stage at step 710. The process is very similar to the CHACKS mode in the initial stage among the CN 701, the MICS, and the MCP. When the MICS 702 receives the request for the Pay-CHACKS mode, it inputs the information of the MS 707 into the mCh-DRS 703 at step 711, and mCh-DRS requests the Payment Encoding Key (PME-Key) to the mCh Payment Server (mCh-PS) 705 at step 712. Finally, the mCh-PS develops a PME-Key and delivers it as a Pay-CHACKS plug-in program to the MS to encrypt media channel content for payment protection at step 713. For the user side of the initial stage of the Pay-CHACKS mode, the client node 701 registers and identifies itself between the CN 701 and the MICS 702 at step 714, so this process is the same as the CHACKS mode. The MICS sends a basic plug-in program to the CN to install it to the system to apply the mCh-IP at step 715.

For the normal stage 709 of the Pay-CHACKS mode in the MICS at the user side, the CN 701 requests the MDN channel to a mCh-DRS 703 at step 716, and the mCh-DRS decides whether the MDN channel is required a Pay-CHACKS mode or not before resolving the MDN channel to a media server IP. If the MDN channel is needed a Pay-CHACKS mode, the mCh-DRS asks a payment options and channel payment agreement, and collects user information and IP address of the CN for paid channel at step 717. In this step, the MICS works as a payment medium agent between the MS and the CN. As soon as the CN 701 responds the payment options and user information to the mCh-DRS 703 at step 718, the mCh-DRS requests a corresponded Payment Media Decoding Key (PMD-Key) attached with the channel IP of the MS to the mCh-PS 705 of the MICS at step 719. Finally, the mCh-PS sends the Pay-CHACKS plug-in including the PDE-Key and the channel IP of MS to install the plug-in program to the CN system at step 720. Also, the CN sends the delivered channel IP to the MS to request a mCh Internet connection at step 721. In this way the CN can get the paid media contents from the MS of the MP as paid media channels. For the connection steps between the CN and the media provider in the normal stage, the provider encrypts the media contents by the PME-Key and the plug-in of CN decrypts them by the PMD-Key as the Pay-CHACKS mode at step 722.

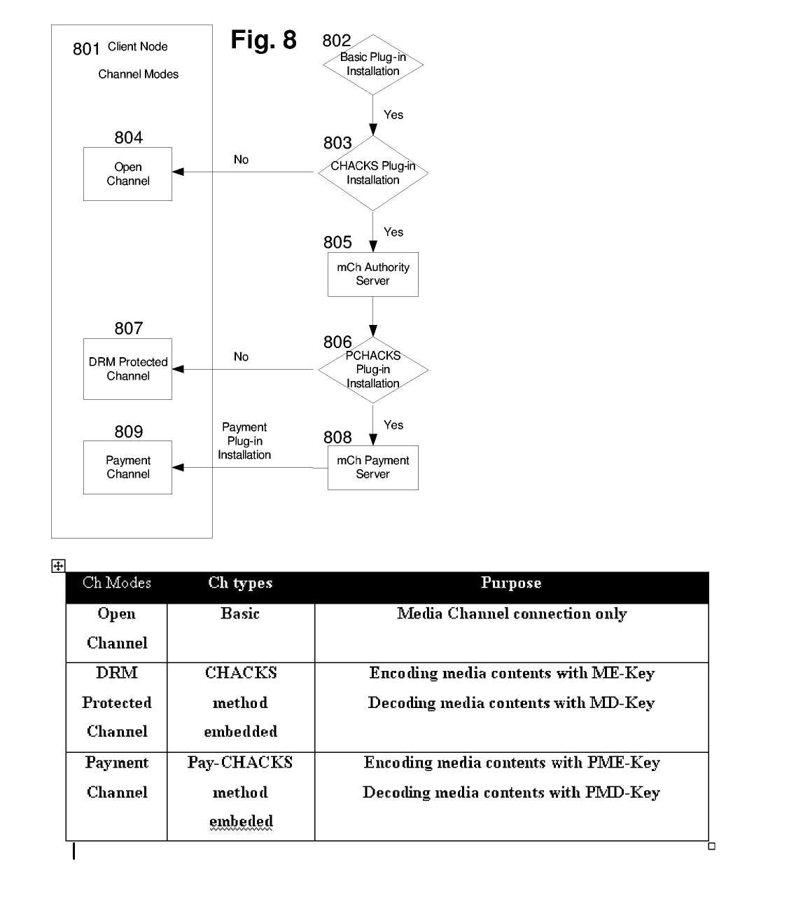

FIG. 8 shows a flow chart of three MICS channel modes, which are an open channel mode 804, a DRM protected channel mode 807, and a payment channel mode 809, classified by the method of provided media contents. At step 802, the MICS determines whether the CN requests a basic plug-in program or not. If the CN agrees to download and install the plug-in program, the MICS further determines whether the requested MDN channel is needing a CHACKS mode or not for the DRM media content protection at step 803. When the MDN channel does not need a CHACKS mode, the CN 801 uses an open channel mode at step 804. This is the first basic type of a channel mode of the MICS, so it just uses the mCh-DNS to connect and get the media contents from the media server of the MDN Channel provider. The channel mode is a paid free and open media content channel for every user who has registration of the MICS as a CN and installs the basic plug-in in the system node.

If the MDN channel required a CHACKS mode, the MICS brings the channel request to the mCh-AS at step 805. At step 806, the MICS determines whether the CN requests the Pay-CHACKS plug-in program or not. If the CN agrees to use the DRM protected service for accessing the media contents, the CN uses the DRM protected channel mode at step 807. The second channel mode is the DRM protected channel mode with the CHACKS method embedded, and it encodes media content with the ME-Key and the client node use the MD-Key to decode the contents. For this channel mode, a CN installs the CHACKS plug-in into the system to connect and get the media content of the MS.

If the MDN channel required the Pay-CHACKS mode, the MDN channel request is brought to the mCh-PS at step 808. At step 809, the mCh-PS sends the payment plug-in program to the CN to install it for using the payment channel mode. This is the last channel mode or the payment channel mode which utilizes the Pay-CHACKS plug-in method. While the MS encrypts the media content with the PME-Key, only the payment registered CN can connect to and access the media content with the PMD-Key.

What is claimed is:

1. A method of connecting to and accessing a variety of media content at the Media Servers (MSs) of Internet Media Channel Providers (MCPs) utilizing Media Domain Name (MDN) channels with a Media Channel-routing Internet Protocol (mCh-IP) from a Media Internet Channel Station (MICS) comprising:
registering a channel IP of the media server or the media content files of the MS corresponded with an MDN channel at a Media Channel Domain Root Server (mCh-DRS) of said MICS on behalf of the MCP;
applying at the MICS a client node (CN) as a user to connect to and access media channels on behalf of the CN;
installing a basic plug-in program received at a client node from said MICS to recognize the MDN channel;
establishing an interconnecting private tunnel between said client node and said mCh-DRS through the plug-in;
transmitting the MDN channel received at the mCh-DRS from the client node through the interconnecting private tunnel;
resolving at said mCh-DRS said MDN channel to the channel IP of the media server or the media content files of the MS;
receiving at the client node from the mCh-DRS the channel IP of the media server or the media content files of the MS; and
connecting said client node to said corresponding media server directly.

2. The method of claim 1, wherein the media contents comprise of TV, radio, movie, music, mp3, photo, or text message.

3. The method of claim 1, wherein said mCh-DRS grants said MDN channel fixed media station privileges.

4. The method of claim 3, wherein said MDN channel adapts a direct-connecting and accessing method.

5. The method of claim 4, wherein the MICS provides a peer-to-peer network connection.

6. The method of claim 3, wherein said MDN channel comprises a media prefix in front of an existing Internet domain name each pointing to information associated with a different media type.

7. The method of claim 6, wherein said media prefix comprises ch://, tv://, radio://, movie://, music://, mp3://, photo://, or message://.

8. The method of claim 1, wherein said mCh-DRS has a look-up data table for said MDN channel and the corresponding channel IP of the media server.

9. The method of claim 8, wherein said corresponding channel IP comprises the IP address of the media server or the directory of media content files of the MS.

10. The method of claim 1, wherein the client nodes comprise of computers, PDAs, and mobile phone devices.

11. A method of providing a DRM protected channel mode on an MICS utilizing a Channel Access Control Key System (CHACKS) to securely protect the media channel content at MSs of MCPs comprising:
registering the channel IP of the media server or the media content files of the MS at a Media Channel Domain Root Server (mCh-DRS) of said MICS on behalf of the MCP;
providing a Media Encoding Key (ME-Key) from an Media Channel Authentication Server (mCh-AS) to the MCP to encrypt the media channel content;
installing a ME-Key plug-in program into the media providers from the mCh-AS;
applying at the MICS a client node (CN) as a user to connect to and access media channels on behalf of the CN;
installing a plug-in program received at a client node from said MICS to recognize an MDN channel;
establishing an interconnecting private tunnel between said client node and said mCh-DRS through the plug-in;
transmitting the MDN channel received at the mCh-DRS from the client node through the interconnecting private tunnel;
determining in the mCh-DRS whether the MDN channel needs a DRM protected channel mode;
requesting the CHACKS requirement for user authentication to the CN from the mCh-DRS;
requesting a Media Decoding Key (MD-Key) with the channel IP of the MS for the CN to the mCh-AS from the mCh-DRS;
installing a CHACKS plug-in to a client node system to utilize the MD-Key to decrypt said media channel content in the media server of the media provider;
establishing direct connection between said client node and said corresponding media server;
providing encoding channel content requiring the MD-Key for decoding from said media providers to said client node; and
decrypting said encoding channel content of the MS using said MD-Key on behalf of the client node.

12. The method of claim 11, wherein the ME-Key generates a secrete code for encrypting the media channel of the MS.

13. The method of claim 11, wherein the MD-Key generates a secrete code for decrypting the media channel of the MS.

14. The method of claim 13, wherein the MD-Key is distributed from the mCh-AS to the client node when the MDN channel is requested.

15. The method of claim 11, wherein the media content comprises TV, radio, movie, music, mp3, photo, or text message.

16. The method of claim 11, wherein said mCh-DRS grants said MDN channel fixed media station privileges.

17. The method of claim 16, wherein said MDN channel adapts a direct-connecting and accessing method.

18. The method of claim 17, wherein the MICS provides a peer-to-peer network connection.

19. The method of claim 16, wherein said MDN channel comprises a media prefix in front of an existing Internet domain name each pointing to information associated with a different media type.

20. The method of claim 19, wherein said media prefix comprises ch://, tv://, radio://, movie://, music://, mp3://, photo:// or message://.

21. The method of claim 11, wherein said mCh-DRS has a look-up data table for the MDN channel and the corresponding channel IP of the media server.

22. The method of claim 21, wherein said corresponding channel IP comprises the IP address of the media server or the directory of media content files of the MS.

23. The method of claim 11, wherein the client nodes comprise of computers, PDAs, and mobile phone devices.

24. A method of providing a payment channel mode on an MICS utilizing a Payment Channel Access Control Key System (Pay-CHACKS) to securely apply a payment system for media channel content at MSs of MCPs comprising:
registering the channel IP of the media server or the media content files of the MS at a Media Channel Domain Root Server (mCh-DRS) of said MICS on behalf of the MCP;
providing a Payment Media Encoding Key (PME-Key) from a Media Channel Payment Server (mCh-PS) to the MCP to encrypt the media channel content;
installing a PME-Key plug-in program into the media providers from the mCh-PS;
applying at the MICS a client node (CN) as a user to connect to and access media channels on behalf of the CN;
installing a plug-in program received at a client node from said MICS to recognize an MDN channel;
establishing an interconnecting private tunnel between said client node and said mCh-DRS through the plug-in;
transmitting the MDN channel received at the mCh-DRS from the client node through the interconnecting private tunnel;
determining in the mCh-DRS whether the MDN channel needs a payment channel mode;
requesting from the mCh-DRS to the CN the Pay-CHACKS requirement for gathering payment options, user information and a user IP address of the CN;
requesting a Payment Media Decoding Key (PMD-Key) with the channel IP of the MS for the CN to the mCh-PS from the mCh-DRS;
installing a Pay-CHACKS plug-in to a CN system to utilize the PMD-Key to decrypt said media channel content in the media server of the media provider;
establishing direct connection between said client node and said corresponding media server;
providing the encoding channel content requiring the PMD-Key for decoding from said media providers to said client node; and
decrypting said encoding channel content of the MS using said PMD-Key on behalf of the client node.

25. The method of claim 24, wherein the PME-Key generates a secrete code for encrypting a media channel of the MS.

26. The method of claim 24, wherein the PMD-Key generates a secrete code for decrypting a media channel of the MS.

27. The method of claim 24, wherein the PMD-Key is distributed from the mCh-PS to the client node when the MDN channel is requested.

28. The method of claim 24, wherein the media content comprises of TV, radio, movie, music, mp3, photo or text message.

29. The method of claim 24, wherein said mCh-DRS grants said MDN channel fixed media station privileges.

30. The method of claim 29, wherein said MDN channel adapts a direct-connecting and accessing method.

31. The method of claim 30, wherein the MICS provides a peer-to-peer network connection.

32. The method of claim 29, wherein said MDN channel comprises a media prefix in front of an existing Internet domain name each pointing to information associated with a different media type.

33. The method of claim 32, wherein said media prefix comprises ch://, tv://, radio://, movie://, music://, mp3://, photo:// or message://.

34. The method of claim 24, wherein said mCh-DRS has a look-up data table for the MDN channel and the corresponding channel IP of the media server.

35. The method of claim 34, wherein said corresponding channel IP comprises the IP address of the media server or the directory of media content files of the MS.

36. The method of claim 24, wherein the client nodes comprise of computers, PDAs, and mobile phone devices.
